(19) United States
(12) Patent Application Publication
(10) Pub. No.: US 2014/0118520 A1
(43) Pub. Date: May 1, 2014

(54) SEAMLESS AUTHORIZED ACCESS TO AN ELECTRONIC DEVICE

(71) Applicant: MOTOROLA MOBILITY LLC, Libertyville, IL (US)

(72) Inventors: Jiri Slaby, Buffalo Grove, IL (US); Roger W. Ady, Chicago, IL (US); Rachid M. Alameh, Crystal Lake, IL (US); Mark J. Carlson, Round Lake, IL (US); Francis W. Forest, Lake Villa, IL (US); Chad Austin Phipps, Grayslake, IL (US)

(73) Assignee: MOTOROLA MOBILITY LLC, Libertyville, IL (US)

(21) Appl. No.: 13/662,600

(22) Filed: Oct. 29, 2012

(51) Int. Cl. G06K 9/00; H04N 7/18

(52) U.S. Cl. 348/77; 340/5.52; 340/5.53; 348/E07.085

(57) ABSTRACT

An electronic device and a method for enabling seamless access to the electronic device are disclosed herein. The method includes assessing, via a first processor, an initial stationary state of the electronic device; and monitoring at least one sensor of the electronic device to determine user interaction with the electronic device. In addition, motion of the electronic device is detected as is any subsequent secondary stationary state within a predetermined time period. An authentication procedure is initialized in the background based on proximity to a user and expiration of the predetermined time period.

### FIELD OF THE DISCLOSURE

The present disclosure generally relates to wireless and wired communication and more particularly to easing a user's ability to unlock or access secured contents and functions of an electronic device.

### BACKGROUND

User authentication is a central security feature of currently employed wireless and wired communication devices. User authentication means determining whether a person attempting to access a system is authorized for such access. In general, user authentication methods fall into three broadly defined categories, the categories are related to 1) certain information that the user has knowledge of, such as a password, or 2) certain information which the user has possession of, such as a token, or 3) one or more physical characteristics of the user, such as the user's fingerprint profile.

These three categories of user authentication for accessing an electronic device such as a smartphone, tablet, or Ultrabook computer each require an obtrusive action to be performed by the user of the electronic device. For example, passwords that may be input by a user have to be remembered, and the corollary of remembering the password is the real world possibility that a user of the electronic device might forget a difficult password. Passwords are also susceptible to hackers. Many users make a conscious decision to not secure their smartphones, for example, because of the added time and effort they would have to exert in memorizing a an acceptably secure password, inputting the password, changing the passing word, memorizing the changed password, inputting the correct changed password, etc. for the purpose of accessing their captured images or texting their friend, for example.

Other password concerns for users include keeping their password safe from unauthorized users and preventing others from viewing their password during manual inputting of the password into a displayed user interface of the electronic device. Frequent changing of the password is also required and necessitated according to industry security experts. These same industry security experts mandate ever more complex variations of passwords, which increases user's frustrations.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram showing example internal components of the electronic device in accordance with one or more described illustrative embodiments.

FIGS. 2A & 2B is a flowchart showing example steps of operation of the electronic device in accordance with one or more described illustrative embodiments.

FIGS. 3A & 3B is another flowchart showing example steps of operation of the electronic device in accordance with one or more described illustrative embodiments.

FIG. 4 is an illustrative schematic showing an embodiment configured for either a facial, iris, retina, eye vein, face vein, and/or other facial feature recognition operation.

FIG. 5 is an illustrative schematic showing a voice pattern recognition operation.

FIG. 6 is a schematic illustrating example movements of the electronic device that will be monitored in one or more embodiments.

FIGS. 7A and 7B illustrate by way of example an array of facial images from different perspectives.

FIG. 8 is an illustrative front view of a human eye.

FIG. 9 is an illustrative detailed view of a human eye.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present disclosure resides primarily in combinations of method steps and apparatus components related to a method and system for seamlessly unlocking or accessing an electronic device. Accordingly, the apparatus components and method steps have been represented where appropriate by conventional symbols in the drawings, showing only those specific details that are pertinent to understanding the present disclosure, so as not to obscure the disclosure with details that will be readily apparent to those of ordinary skill in the art, having the benefit of the description herein.

An electronic device and a method for unlocking the electronic device is disclosed herewith. The method includes assessing, via a first processor, an initial stationary state of the electronic device and monitoring at least one sensor of the electronic to determine user interaction with the device. To provide greater assurance of a user's interaction with the electronic device, movement corresponding to the electronic device is initially detected and thereafter a secondary stationary state, also corresponding to detected movement of the electronic device, but within a predetermined time period of the initial detected movement or motion of the electronic device. The one or more internal sensors of the electronic device aids detection of movement of the electronic device An authentication procedure may be initialized, based on the electronic device's proximity to a user and expiration of the predetermined time period corresponding to the electronic device obtaining the secondary stationary state as detected by one or more sensors within the electronic device.

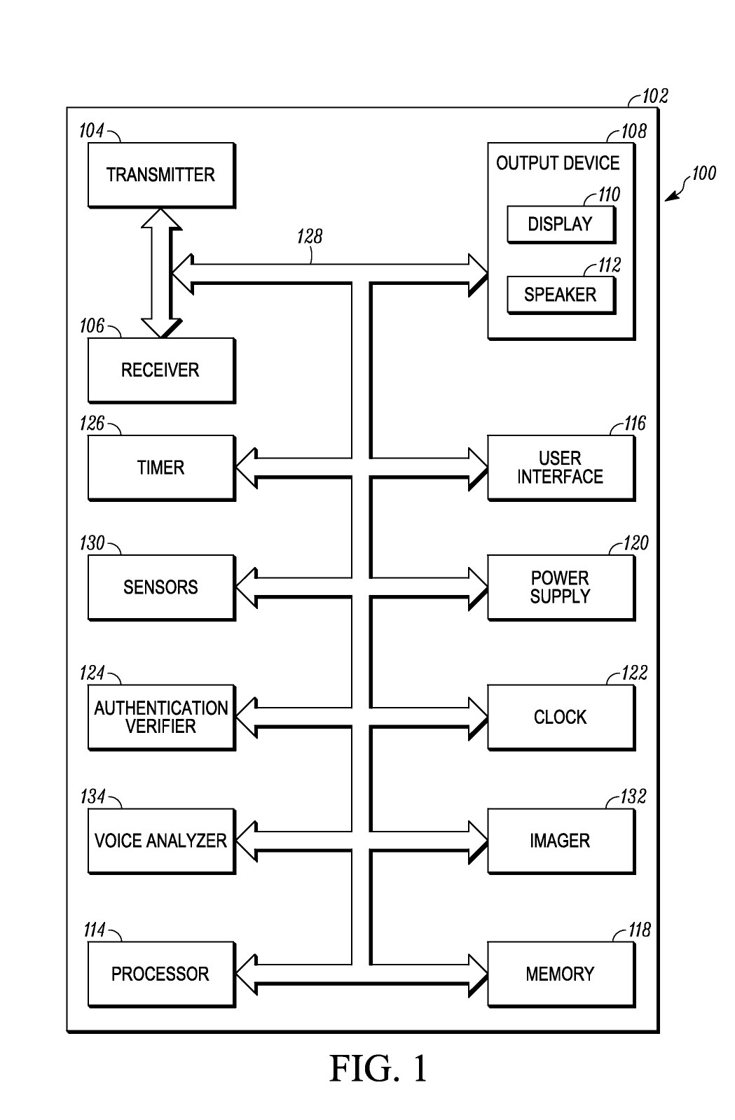

Referring to FIG. 1, an example wireless or wired communication system 100 is shown in a block form that is intended to be representative of a variety of different wireless or wired communication systems that may be envisioned by those skilled in the art. In one embodiment, the wireless or wired communication system 100 includes internal hardware components of an electronic device 102, for example, an electronic wireless communications device.

The block diagram for system 100 of the electronic device 102 includes various electronic components configured for enabling network communication and sensory input and output for the electronic device 102. The example components include a transmitter 104, a receiver 106, an output device 108 including a display 110 and an acoustic output device such as a speaker 112, a processor 114, a user interface 116, a memory 118, a power supply 120, a clock 122, an authentication verifier 124 and a timer 126, each capable of communicating with one or more components of the electronic device 102. For example, as shown in FIG. 1, all electronic components are coupled to a bidirectional system bus 128, having one or more of a data communication path, a control communication path or a power supply path. Other contemplated operational electronic components for the electronic device 102, but not shown in FIG. 1 may include a microphone, an appropriate optical sensor or proximity sensor (such as an infra-red light emitting diode and configured sensor receiver) to enable facial, iris, retina, and/or eye vein recognition, for example.

The transmitter 104 enables the electronic device 102 (configured as a communication device) to transmit communication signals and the receiver 106 enables the electronic device 102 to receive RF signals through an antenna (not shown explicitly, but antenna may be either internal or external to the electronic device 102). In accordance with the embodiment, the receiver 106 converts the RF signals received from the antenna to digital data for use by the processor 114. Each transmitter 104 and/or the receiver 106 of the communication device utilizes wireless signaling technology for communication, such as, but are not limited to, peer-to-peer or ad hoc communications such as Bluetooth, Zigbee, near field communication, infrared, peer-to-peer WiFi, wireless HDMI, wireless USB, HomeRF, and the like. Each wireless transceiver 101 may also utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE, LTE-A or IEEE 802.16) and their variants.

The output device 108 may generate visual indications of data generated during operation of the processor 114. The visual indications may include prompts for human operator input, calculated values, detected data, etc. Additionally, the output device 108 may include a video output component such as a display device 110 which may include one or more of the following example display technologies: a cathode ray tube, a liquid crystal display, an OLED display (including AMOLED and super-AMOLED), a plasma display, an incandescent light, a fluorescent light, a front or rear projection display, or a light emitting diode indicator. Other examples of output components 108 include an audio output component such as a speaker 112, alarm and/or buzzer, and/or a mechanical output component such as vibrating or motion-based component, including haptic technology. In addition, electrical connectors may also be included that enable connection to display devices such as a large monitor or a television monitor.

In accordance with one or more embodiments, the user interface 116 may be connected to the processor 114 for entering data and commands in the form of text, touch input, gestures, etc. The user interface 116 is, in one embodiment, a touch screen device, but may alternatively be an infrared proximity detector or sensor or any input/output device combination capable of sensing gestures and/or touches including a touch-sensitive surface. In addition, the user interface 116 may include one or more additional components, such as a video input component such as an optical sensor (for example, a camera or CCD or CMOS imaging technology), an audio input component such as a microphone, and a mechanical input component such as button or key selection sensors, a touch pad sensor, another touch-sensitive sensor, a capacitive sensor, a motion sensor, and/or a pointing device such as a joystick and controllable motion buttons, a track ball, a touch pad, a rocker switch, a touch screen, a TTY input device for disabled persons, a Braille key input, a fingerprint sensor, or a pad for an electronic stylus, for example. One or more of these user interface devices may function in multiple modes. That is a fingerprint sensor may also function as a touch pad or trackpad, for example. The user interface 116 enables a user of the communication device 102 to provide an input for the communication device 102.

Still referring to FIG. 1, the memory 118 may be used to store data and instructions for the operation of the processor 114. In various embodiments, the memory 118 may be one or more separate components and/or may be partitioned in various ways for various purposes such as but not limited to, optimizing memory allocations, etc. Thus, it is to be understood that memory 118 illustrated in FIG. 1 is for illustrative purposes only, for the purpose of explaining and assisting one of ordinary skill in understanding the various embodiments described herein.

Additionally, the power supply 120, such as a battery, may be included in the internal components of the electronic device 102 for providing power to the other internal components while enabling the electronic device 102 to be portable. The power supply 120 may also be configured for greater optimization, such as reduction of current loss and may be connected via circuitry to other components for greater efficiency of power usage by the electronic device 120.

Furthermore, the authentication verifier 124 of FIG. 1 is configured to verify different authentication means such as facial, iris, retina, eye vein, and/or face vein recognition or other facial feature or facial component, password recognition, fingerprint recognition, and voice pattern recognition, for example. The authentication means may be stored in memory 118. The authentication verifier may also draw upon stored information in memory 118, such as a look up table to compare and contrast data, including data related to information on facial, iris, retina, and/or eye vein information, fingerprints, breath analysis, body odor, voice patterns, etc. The electronic device 102 further includes a clock 122 and a timer 126. The timer 126 may be synchronized with the clock 122 and measures time intervals. In another embodiment, the timer 126 and the clock 122 may be integrated together as a single unit.

Moreover, the processor 114 operates in conjunction with the data and instructions stored in the memory 118 to control the operation of the communication device 102 and monitor sensors 130. The processor 114 may be implemented in many different forms, for example as a microcontroller, a digital signal processor, hard-wired logic and analog circuitry, or any suitable combination of these forms and formats. The sensors 130 may be capacitive-type sensors, force-based sensors, proximity sensor, ambient light sensor, acoustic sensors, piezo-electric sensors, thermal-touch sensors, proximity sensors, touch sensors, fingerprint sensors, imaging sensors, or accelerometers, magnetometers, and gyroscopes, or any suitable combination of these sensors, for example. The sensors 130 may be directly coupled to one or more timers 126 to aid in determining how long the sensory input received by the sensors 130 has been active or inactive.

It is to be understood that FIG. 1 is for illustrative purposes only and is primarily for, although not solely for, explaining the information that may be stored in memory or captured by one or more sensors for the various embodiments of an electronic device in accordance with the present disclosure, and is not intended to be a complete schematic diagram of the various components and connections for an electronic device. Therefore, an electronic communication device, for example, will comprise various other components not shown in FIG. 1, and/or have various other internal and external configurations, and still be within the scope of the present disclosure. Also, one or more of these components may be combined or integrated in a common component, or some of the component's features may be distributed among multiple components. Also, the components of the electronic device 102 may be connected differently that that shown in FIG. 1 et al., without departing from the scope of the invention.

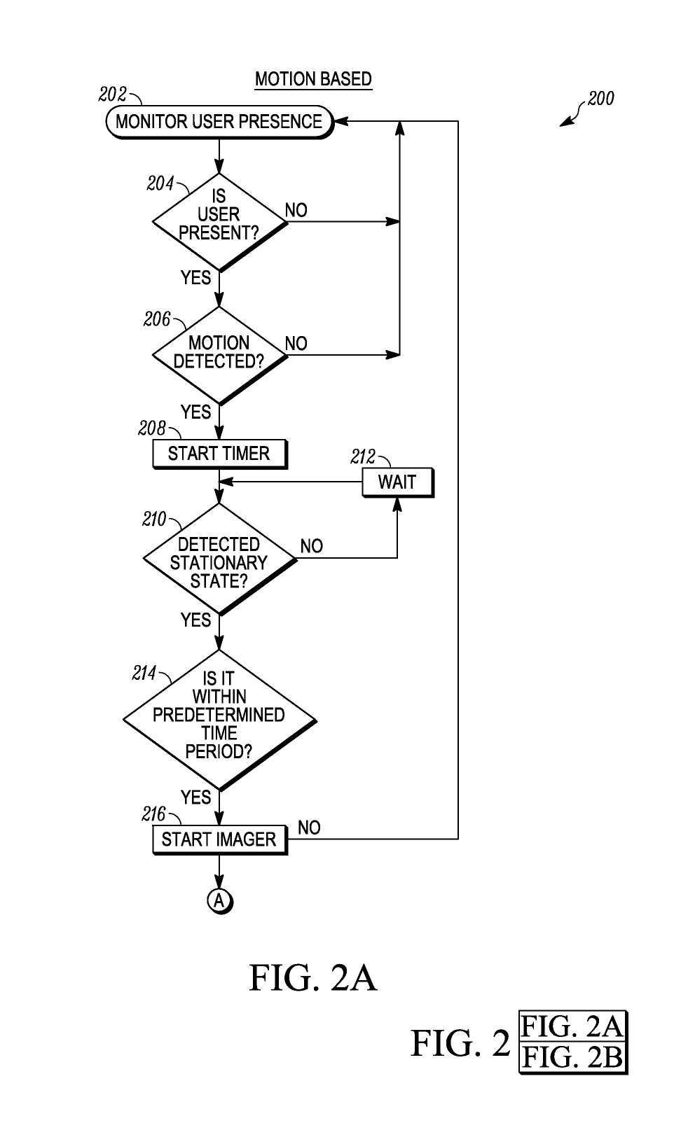

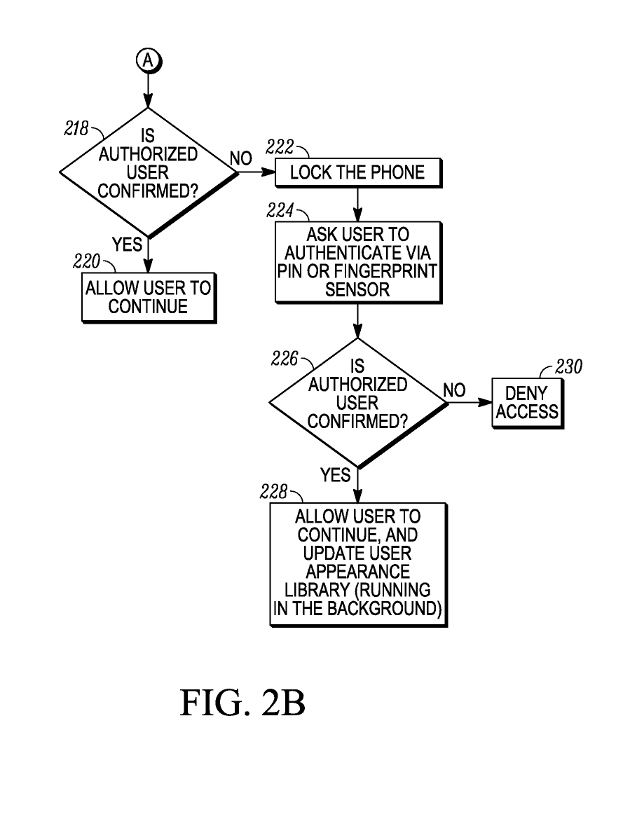

Referring to FIG. 2, a method 200 is provided showing example steps of unlocking the electronic device via recognition of user presence and of detected motion associated with movement of the electronic device. In accordance with the present embodiment, in step 202 a processor or controller of the electronic device 102 monitors sensors that are configured to sense the presence of a person (i.e., a user of the electronic device) engaged or interacting with the electronic device 102.

Step 204 detects the presence of the user of the electronic device 102 via one or more sensors 130, such as a sensor configured to detect hand contact with the electronic device 102 (e.g., a capacitive touch sensor or force-based sensor, a proximity sensor, or a temperature based sensor). If a user is affirmatively detected by one or more sensors 130, the process or method proceeds with step 206 for determining whether motion of the device or corresponding to movement or gesturing with the electronic device 102 has been detected; otherwise, the process returns to step 202 for monitoring the presence of a user. If a motion corresponding to the electronic device 102 has been affirmatively detected in step 206, via a sensor 130, such as an accelerometer, magnetometer, and/or gyroscope, then step 208 starts a timer 126 for counting how long the sensor 130 receives motion information about the device 102; otherwise, the process returns to step 202 for monitoring the presence of a user. Additional sensors 130 may be employed and are contemplated herein for their unique sensing abilities, including a global positioning sensor (GPS) that is able to sense and provide location information and a barometric sensor capable of providing pressure change information should the electronic device be held at different heights.

The timer 126 continues to run until step 210 detects a stationary state of the electronic device; that is the device has stopped moving as sensed by sensors 130 and determined by processor 114, for example. If step 210 affirmatively detects that the electronic device is stationary, then the process continues with step 214 wherein the processor 114 determines whether the cessation of motion for the electronic device has occurred within a predetermined period of time; otherwise, the process continues with step 212 in which a wait procedure is enacted until an affirmatively detected stationary state by step 210 occurs.

An input at the electronic device 102 is expected to be received within a predetermined time period or interval. The predetermined time may be set by the user of the electronic device 102. The electronic device 102 includes the timer 126 and the clock 122 as shown in FIG. 1. The timer 126 of FIG. 1 monitors the set predetermined time and provides a signal on the expiration of the set predetermined time. If motion of or corresponding to the electronic device has ceased within the set predetermined time, then the process continues to step 216, wherein an imager 132 is enabled.

Step 218 of FIG. 2 determines whether an authorized user is confirmed. That is, has the imager 132 of the electronic device captured a face, iris, eye vein pattern, and/or retina pattern that is recognized and verified by authentication verifier 124 as belonging to or associated with an authorized user for the electronic device? If the face or another feature or component of the face (e.g., iris, retina, face vein, or eye vein pattern) is verified as an authorized user and thus step 218 is affirmatively decided, the process continues with step 220 that allows or enables the now recognized authorized user to continue using the electronic device 102 to access secure files, data, and other features or functions of the electronic device 102; otherwise step 222 will lock and secure the electronic device 102 to prevent use of sensitive information and data, until the user is authenticated via other authentication means.

If rejection of the user as an authenticated person does occur, additional or alternative authentication procedures such as coded pin entries, passwords, or fingerprints, for example, are employed in step 224 to further determine authentication of the user in step 226, wherein an inquiry is made on whether the user's authorization can indeed be confirmed. If user authorization in step 226 is affirmatively confirmed, then step 228 allows a user to continue, while simultaneously expanding an user appearance library in memory 118 of the electronic device 102. Hence, in the appearance library old or previous images may be retained for use as comparable images during authentication. These images are contemplated to include facial images comprising distorted faces, bruised faces, aged faces, and facial image components such as retina, irises, eye veins, face veins, bridges of noses, and ear structures, for example. The images in the appearance library also include images that were captured under various ambient lighting conditions. The appearance library may be accessible and run continuously as background software on the electronic device 102 or may reside in a remote server. If authorization in step 226 is not confirmed, then step 230 denies access to the user of electronic device to secured contents within the electronic device.

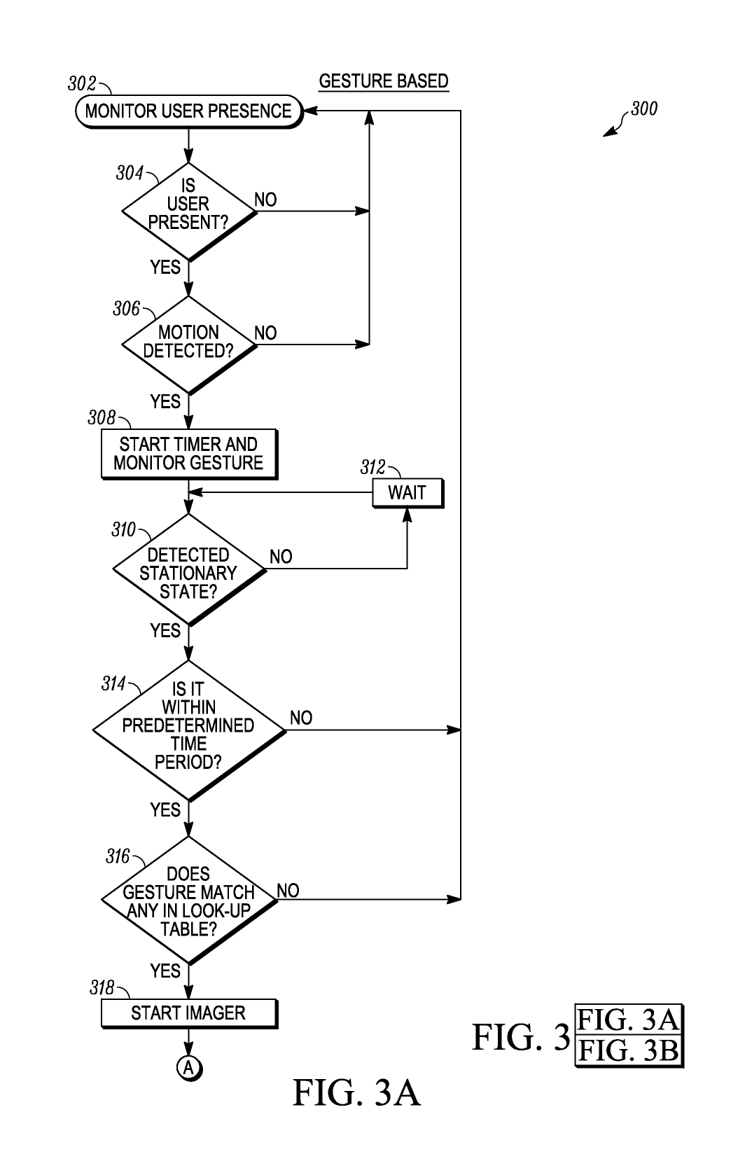

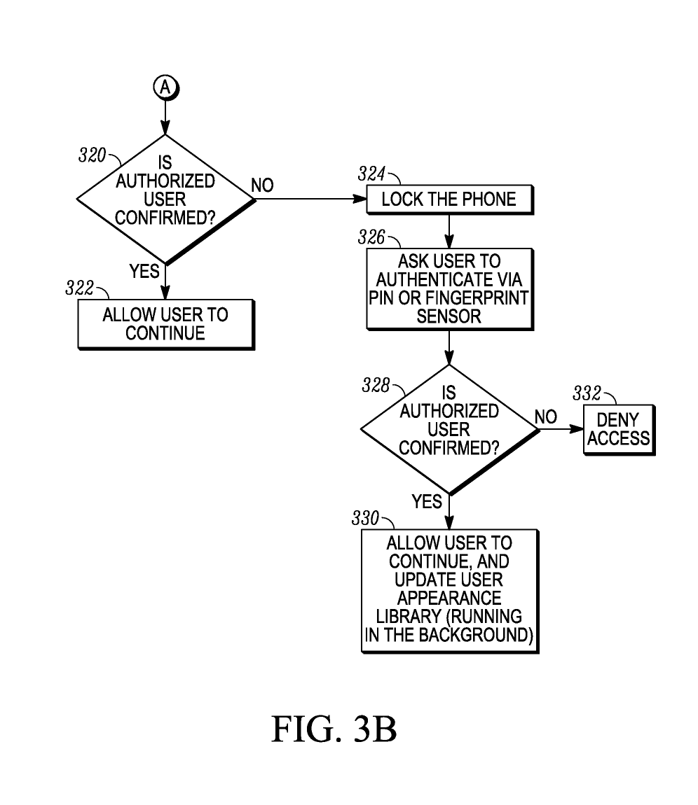

Referring to FIG. 3, a flowchart 300 is provided showing example steps of unlocking the electronic device via recognition of a gesture to trigger an imager. In accordance with at least one embodiment, a processor or controller of the electronic device 102 monitors sensors in step 302 that are configured to sense the presence of a person (i.e. a user of the electronic device 120) engaged or interacting with the electronic device 102.

Step 304 detects the presence of a user via one or more sensors 130, such as a capacitive sensor or other similar touch sensor for sensing fingers that may be gripping or holding the electronic device, or a proximity sensor for illuminating a user's face as it is within a predetermined distance or range to the electronic device 102, for example. If a user is affirmatively detected, the process or method proceeds with step 306 for determining whether motion of the device or corresponding to the electronic device 102 has been detected; otherwise, the process returns to step 302 for monitoring the presence of a user. If motion has been affirmatively detected in step 306, via a sensor, such as an accelerometer, magnetometer, barometer, or gyroscope, then step 308 starts a timer for counting how long the sensor receives motion information about the device, and monitors a likely detected gesture; otherwise, the process returns to step 302 for monitoring the presence of a user. Herein, a gesture differs from motion corresponding to movement of the electronic device in that a gesture is contemplated herein as the electronic device undergoing a motion having a defined path and/or pattern. Gestures may be detected across multiple users, or a device may be used for detecting its owner's gesture relative to the electronic device 102.

The timer 126 continues to run until step 310 detects a stationary state of the electronic device; that is the device has stopped moving as sensed by sensors 130 and determined by processor 114, for example. If step 310 affirmatively detects that the electronic device is stationary, then the process continues with step 314 wherein the processor 114 determines whether the cessation of motion for the electronic device has occurred within an acceptable predetermined period of time; otherwise, the process continues with step 312 in which a wait procedure is enacted until a detected stationary state by step 310 occurs.

For example, an input, at the electronic device has to be received within a predetermined time. The predetermined time may be set by the user of the electronic device 102. The electronic device 102 includes the timer 126 and the clock 122 as shown in FIG. 1. The timer 126 of FIG. 1 monitors the set predetermined time and provides a signal on the expiration of the set predetermined time. If motion of or corresponding to the electronic device has not ceased within the set predetermined time, then the process returns to step 302 for monitoring the presence of a user. If motion of or corresponding to the electronic device has ceased within the set predetermined time, then the process continues to step 316, wherein an inquiry determines whether the gesture that was monitored in step 308 match any stored gestures in look up table (LUT) of memory 118. If the gesture is affirmatively found in the LUT, then the imager may be started in step 318; otherwise, the process returns to step 302 for monitoring the presence of a user.

Step 320 of FIG. 3 determines whether an authorized user is indeed confirmed as authorized. That is, has the imager of the electronic device captured a face that is recognized and verified by authentication verifier 124 as an authorized user for the electronic device? If the face is verified as an authorized user and thus step 320 is affirmatively decided, the process continues with step 322 that allows or enables the now recognized authorized user to continue using the device to access secure files, data, and other previously locked features or functions of the electronic device; otherwise step 324 will lock and secure the phone and prevent its further use of or disclosure of sensitive information and data, until the user is authenticated via other authentication means.

Additional or alternative authentication procedures such as coded pin entries, passwords, or fingerprints, voice patterns, for example, may be employed in step 326 to further determine authentication of the user in step 328 wherein a second inquiry is made on whether the user's authorization can be confirmed. If authorization in step 328 is affirmatively confirmed, then step 330 allows a user to continue, while the processor or controller simultaneously expands an appearance library comprised of acceptable, authorized facial images (including identifiable parsed facial components such as irises, retinas, face veins, and eye veins, for example) in memory 118 of the electronic device 102. Old facial images, for different authentication conditions, may also be retained in the appearance library. The appearance library may be accessible and run or operated continuously as background software on the electronic device or may reside in a remote server. If authorization in step 328 is not confirmed, then step 332 denies access to the user of electronic device to secured contents within the electronic device.

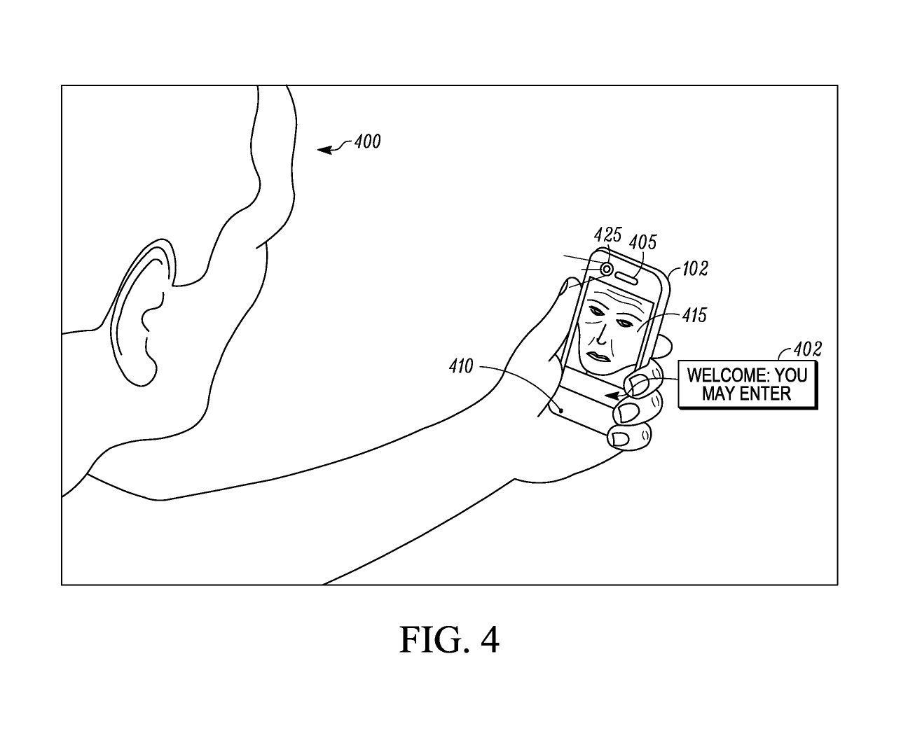

FIG. 4 illustrates a user 400 interacting with electronic device 102, in this illustrated example—a smartphone is shown. The electronic device 102 includes a camera 405 powered by an imaging sensor, such as a charge coupled device or a complementary metal oxide sensor, for example. Electronic device 102 further includes a microphone 410 for capturing spoken utterances from user 400. A facial image 415 is shown, for illustration purposes, as that of user 400 that was captured by or at least analyzed by the imager sensor within the electronic device 102 in the background while user was performing his desired task; e.g., seamless authentication. Complete seamless authentication, in one embodiment, avoids placing an image 415 on the display screen of the electronic device 102. However, it is contemplated herein that a user 400 may prefer a thumbnail image 415, for example, be displayed on display screen. The electronic device 102 recognizes the facial image 415 due to one or more methods as described by way of example in FIGS. 2 and 3. The electronic device 102 may also be configured, via a processor, to recognize an iris pattern, an eye vein pattern, and/or a retinal image as captured by a camera or imager electronically coupled to the electronic device 102. A notification 420, {“WELCOME: YOU MAY ENTER”}, may or may not be displayed as this is an authentication method or process programmed to run, function, or operate in the background; and thus may not be immediately obvious to the user of the electronic device. However, the notification may inform the user 400 that the user 400 is recognized as authorized for accessing secure data or content held by electronic device 102. Notification 420 may be textual and/or visually displayed, or may be an audio notification to the user 400 of the electronic device 102.

In addition, an LED or front facing proximity sensor 425, such as infra-red (IR) LED, for example, may be used in some or all cases to illuminate user's face and to provide proximity/distance information, as the user gazes upon the front of the display in engagement with the electronic device 102, to improve the camera or imager sensor recognition by minimizing the effects of ambient light on facial, iris, retina, and/or eye vein recognition systems; thereby improving authentication reliability. The electronic device 102 may also be configured to capture images of the user's iris, retina, and/or eye veins for subsequent comparison with an approved database of authenticated images. The database may be stored locally in the memory 118 of the electronic device 102 or may be stored at a remote server or in a portable memory device, such as a USB memory stick, or SD card, for example.

The electronic device 102 may also be configured with auto-focus hardware and software and have anti jitter algorithms implemented within one or more processors to enable stability and greater reliability of the data points from the captured facial image. Furthermore, several imagers may be employed to capture several different angles of the user of the electronic device and thereafter employ stitching algorithms to construct a reliable facial image of the user; thereby improving speed of the authentication procedure via facial image recognition.

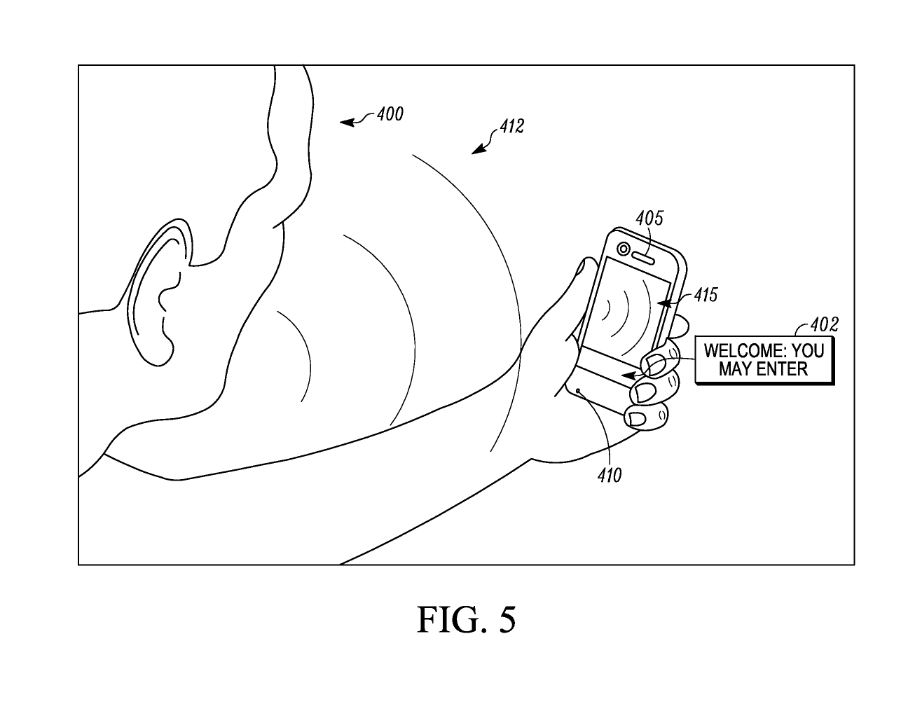

FIG. 5 illustrates a user 400 interacting with electronic device 102. The electronic device 102 includes a camera 405 powered by an imaging sensor, such as a charge coupled device or a complementary metal oxide sensor, for example. Electronic device further includes a microphone 410 for capturing spoken utterances from user 400. User 400 is shown speaking an utterance 412 that becomes a voice pattern 415. The voice pattern 415 is analyzed by a processor in electronic device 102 subsequent to sensing by an acoustic sensor, for example; and its recognition as an authorized voice pattern may be processed by a similar method shown by way of example in the flowchart 300 of FIG. 3. That is, a voice pattern recognition method may augment the facial image recognition method, such as when the electronic device is configured to unobtrusively monitor the user's voice (during the device's idle states, for example) or alternatively when direct, intentional voice input from the user is received by the electronic device to aid the electronic device's imager and augment the authorization method.

Accordingly, recognized voice pattern 415 is shown on display of electronic device along with an optional notification 420 to inform user 400 that the user has access to secure data and contents held by electronic device 102. Notification 420, {“WELCOME: YOU MAY ENTER”}, may be textual and/or visually displayed, or an audio notification to the user 400 of the electronic device 102. Alternatively, no visual display related to the processing of the voice pattern may be evident to the user to further enhance seamless or unobtrusive authentication performed or programmed to run or operate in the background.

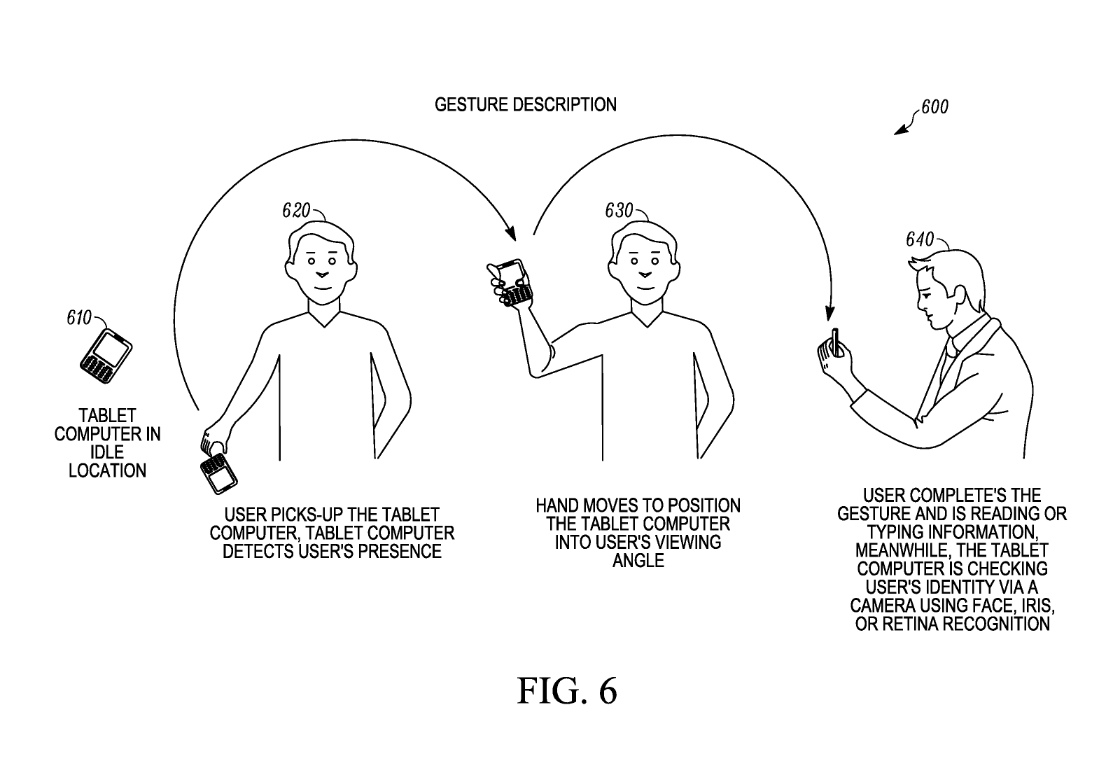

Referring to FIG. 6, a schematic of an example gesture movement 600 capable of being captured and analyzed by the electronic device 102 is shown. Initially, electronic device 102 may be in an idle or stationary position 610, in this illustrated example—a tablet computer is shown. As described above, electronic device 102 is configured with sensors 130 to sense or detect a user's presence, such as when the user picks up the electronic device 102 in position 620. Position 630 illustrates the electronic device 102 being moved into a predetermined position via a recognized movement, in a predetermined path that includes the user's viewing angle of the electronic device 120. A full frontal display position for the user's face provides position 640 and completes the gesture movement 600. At position 640, the user is able to read content information or type or speak input information, while the electronic device 120 is configured to use a camera to conduct facial, iris, retina, and/or eye veins recognition of the user in a seamless manner; that is the authentication procedure does not require active input from the user and avoids memorization of code pins and passwords for initial access to stored contents within the electronic device.

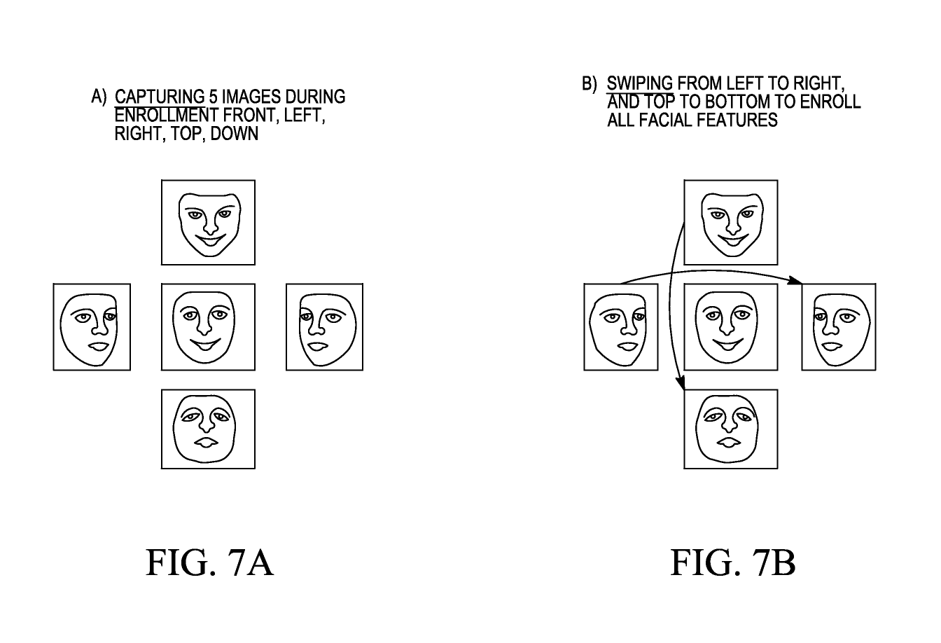

As with all biometric and password access approaches, a mobile communication device user has to first enroll in an authentication means. In the case of a secure password, the user has to initially set-up an acceptable secure password. In the case of biometrics, the user has to initially enroll his/her biometric features via image capture of the particular acceptable physical feature. For facial recognition, the acceptability of a user's face as a means of authentication can be further improved by enrolling the user subsequent to capturing a frontal view image of the user, as well as additional facial images of the user from the user's angular left, right, top, and bottom. FIG. 7A illustrates example frontal, left, right, top, and bottom perspective images of a user's face.

FIG. 7B shows an embodiment that allows for swiping, transferring, or swapping various positions containing an image of a user's face in an array. The user's facial image may be swiped, transferred, or swapped from left side to right side, and from top side to bottom side (alternatively, the swiping or swapping directions may be reversed as well). The multiple images of the user's face from different angles or perspectives as seen in FIGS. 7A and 7B can be included in an image template for reference when the user is looking at the display sideways or from a position not exactly frontal or substantially ninety degrees with respect to the display. The image template enhances the facial recognition authentication procedure, which occurs in a manner that is unobtrusive to the user as the user engages with his mobile communication device, for example.

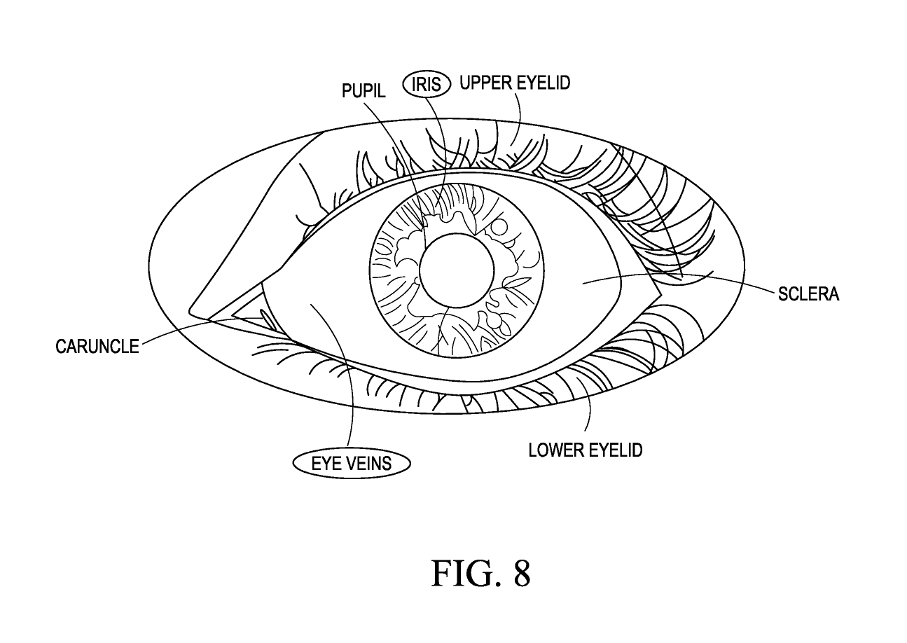

FIG. 8 shows various parts of a person's eye. Optical scanning of a person's iris or veins (also referred to as vortex veins, blood vessels) within the sclera or choroid of the eye can lead to identification of the person, because of the unique traits or patterns associated with the iris or eye veins. The electronic device herein may be configured to scan and decipher these patterns for identification purposes that can be utilized for access to authorized, secure information within the mobile communication device.

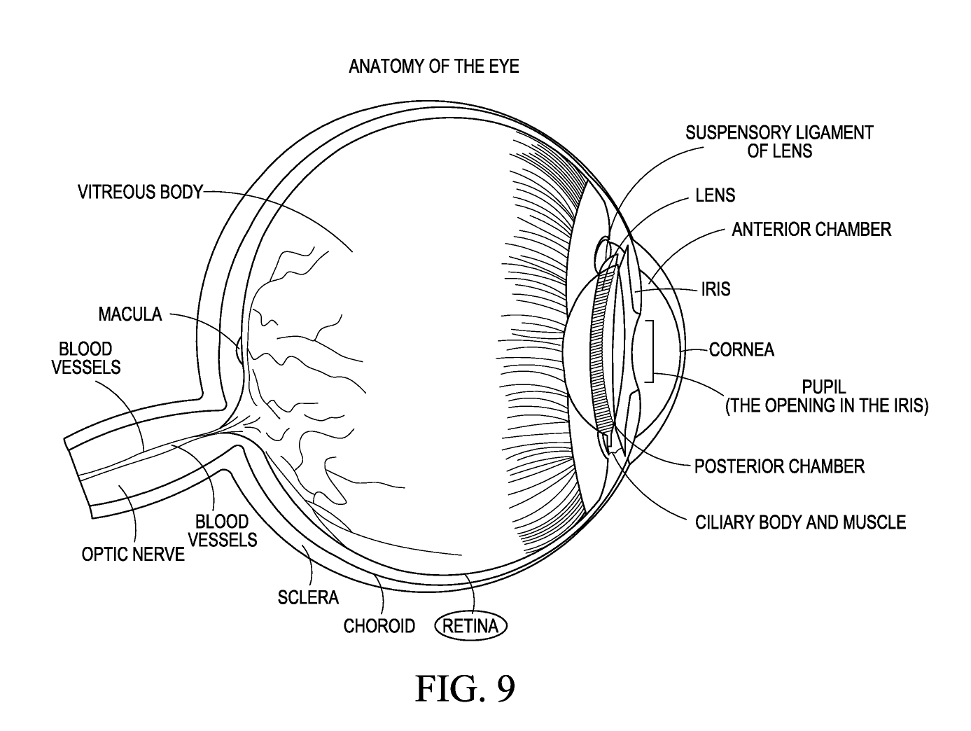

FIG. 9 also shows various parts of a person's eye, but from a side perspective. In this perspective one is able to see the retina, which has its own unique traits or patterns that can be captured with optical scanning for identifying a person. The mobile communication device herein may be configured to scan and decipher these patterns for identification purposes that can be utilized for access to authorized, secure information within the mobile communication device.

Seamless authentication is defined herein as occurring in the background of the user interface and not directly or immediate to the user's attention. That is the user is not required to directly engage the user interface or input method of a keyboard (physical or virtual), for example to gain access to secured information. In some cases, it is contemplated that the user may be unaware that he is being authenticated as he performs other tasks with the device, such as texting or viewing messages or viewing photographs, for example. Yet, by merely grasping the electronic device and having a touch sensor (capacitive or resistive) or proximity sensor detect the touch, the processor of the electronic device can trigger the start of an authentication procedure.

In the foregoing specification, specific embodiments have been described. However, one of ordinary skill in the art appreciates that various modifications and changes can be made without departing from the scope of the invention as set forth in the claims below. For example other biometric sensors may be adapted and configured for authentication, including breath analyzers, skin sensory receptors, sweat sensors, body odor sensors, and saliva sensors. Accordingly, the specification and figures are to be regarded in an illustrative, rather than a restrictive sense; and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for enabling seamless authorized access to an electronic device, comprising:
assessing, via a first processor, an initial stationary state of the electronic device;
monitoring a front facing proximity sensor configured to provide illumination upon a face of a user interacting with the electronic device to aid in determining amount of user interaction with the electronic device;
detecting motion of the electronic device and subsequent secondary stationary state within a predetermined time period; and
initializing an authentication procedure based on proximity to the user of the electronic device and expiration of the predetermined time period.

2. The method of claim 1, wherein the user interaction includes gesturing correlated with the electronic device.

3. The method of claim 2, wherein the gesturing is included in a stored gesture profile within the electronic device.

4. The method of claim 1, wherein the authentication procedure is further comprised of at least one of facial image recognition, iris image recognition, retinal image recognition, face vein recognition, eye vein image recognition, and/or voice pattern identification.

5. The method of claim 1, wherein the predetermined time period begins upon the detection of the user interaction with the electronic device.

6. The method of claim 1, wherein determining the user interaction with the electronic device includes sensing user touch upon the electronic device.

7. The method of claim 1, wherein determining the user interaction with the electronic device includes user viewing the electronic device.

8. The method of claim 4, further comprising augmenting facial image or facial image component recognition processing with location sensors, biometric sensors, calendar events, and/or voice.

9. The method of claim 1, further comprising a second processor independent of the first processor for sensor monitoring and data augmentation.

10. The method of claim 1, further comprising waking up the first processor upon the need to activate an imager to enable facial identification.

11. The method of claim 1, wherein the front facing proximity sensor of the electronic device is an infra-red light emitting diode.

12. A method for enabling seamless authorized access to an electronic device in motion, comprising:
assessing, via a motion detecting sensor, motion status of the electronic device;
monitoring a front facing proximity sensor of the electronic device that is configured to provide illumination upon a face of a user interacting with the electronic device to aid in determining amount of user interaction with the electronic device;
detecting touch of the electronic device and subsequent secondary stationary state within a predetermined time period; and
initializing an authentication procedure based on proximity to a user and expiration of the predetermined time period.

13. The method of claim 12, further comprising:
employing voice pattern recognition analysis to augment facial recognition, based on spoken utterances from the user of the electronic device, as the authentication procedure.

14. The method of claim 12, wherein the predetermined time period begins upon the detection of the user interaction with the electronic device.

15. The method of claim 12, further comprising notifying the user of the electronic device of a successful or completed authentication procedure.

16. The method of claim 15, wherein notifying the user of the electronic device is implemented via a textual or audio message.

17. An electronic device, comprising:
a touch sensor for sensing user presence and interaction with the electronic device;
an accelerometer for detecting motion of the electronic device;
an imager for capturing a facial image of user interacting with the electronic device; and
a front facing LED proximity sensor configured to provide illumination upon a face of the user interacting with the electronic device; and
a processor for analyzing inputs from the touch sensor, the accelerometer, the front facing proximity sensor, and the imager within a predetermined time period to configure the electronic device to permit authorized access to a recognized user.

18. The electronic device claimed in claim 17 further comprising:
a location sensor for providing location information to a processor for augmenting facial image recognition to increase system authentication confidence.

19. The electronic device claimed in claim 17 further comprising:
a biometric sensor for providing biometric information to the processor for augmenting confidence of facial image recognition to increase system authentication confidence.

20. The electronic device claimed in claim 17 wherein the processor retrieves information from a calendar event for augmenting confidence of facial image recognition to increase system authentication confidence.
